(19) United States
(12) Patent Application Publication
(10) Pub. No.: US 2012/0237693 A1
(43) Pub. Date: Sep. 20, 2012

(54) IN-SITU CLEAN PROCESS FOR METAL DEPOSITION CHAMBERS

(75) Inventors: Michael Jackson, Sunnyvale, CA (US); Song-Moon Suh, Sunnyvale, CA (US); Arvind Sundarajjan, San Jose, CA (US); Murali K. Narasimhan, San Jose, CA (US); Sriskantharajah Thirunavukarasu, Singapore (JP)

(73) Assignee: APPLIED MATERIALS, INC., Santa Clara, CA (US)

(21) Appl. No.: 13/422,425

(22) Filed: Mar. 16, 2012

Related U.S. Application Data
(60) Provisional application No. 61/453,934, filed on Mar. 17, 2011.

(51) Int. Cl. B05D 3/06; B05D 3/14; B05D 3/04

(52) U.S. Cl. 427/534; 427/349

(57) ABSTRACT

Embodiments of the invention include methods for in-situ chamber dry clean for metal deposition chambers. In one embodiment, a method for in-situ chamber dry clean after a metal deposition process includes placing a substrate in a processing chamber, performing a metal deposition process on the substrate in the processing chamber, removing the substrate from the support pedestal, and performing an in-situ cleaning process by supplying a cleaning gas containing H₂ to the processing chamber while a dummy substrate is disposed in the processing chamber

### CROSS REFERENCE TO RELATED APPLICATIONS

This application claims benefit of U.S. Provisional Patent Application No. 61/453,934, filed Mar. 17, 2011, which is incorporated by reference in its entirety.

### BACKGROUND

1. Field

Embodiments of the present invention generally relate to method and apparatus for cleaning a processing chamber. Particularly, embodiments of the present invention relate to methods and apparatus for in-situ cleaning a processing chamber for metal deposition applications.

2. Description of the Related Art

Reliably producing submicron and smaller features is one of the key technologies for the next generation of very large scale integration (VLSI) and ultra large scale integration (ULSI) of semiconductor devices. However, as the fringes of circuit technology are pressed, the shrinking dimensions of interconnects in VLSI and ULSI technology have placed additional demands on the processing capabilities. The multilevel interconnects that lie at the heart of this technology require precise processing of high aspect ratio features, such as vias and other interconnects. Reliable formation of these interconnects is very important to VLSI and ULSI success and to the continued effort to increase circuit density and quality of individual substrates.

As circuit densities increase for next generation devices, the widths of interconnects, such as vias, trenches, contacts, gate structures and other features, as well as the dielectric materials therebetween, decrease to 45 nm and 32 nm dimensions, whereas the thickness of the dielectric layers remain substantially constant, with the result of increasing the aspect ratios of the features. Many traditional deposition processes have difficulty filling submicron structures where the aspect ratio exceeds 4:1. Therefore, there is a great amount of ongoing effort being directed at the formation of substantially void-free and seam-free and conformal submicron features having high aspect ratios.

In the manufacture of integrated circuits, a barrier layer, such as a titanium/titanium nitride stack, for example, titanium nitride layer over a titanium layer, is often used as a liner barrier. The titanium/titanium nitride stack may be used to provide contacts to the source and drain of a transistor or interconnection structure. The titanium nitride layer may be used as a barrier layer to inhibit the diffusion of metals into regions underlying the barrier layer in a contact or back end interconnection structure. A conductive metal layer, such as a copper-containing layer, aluminum layer or a tungsten-containing layer, is usually deposited over the titanium nitride layer.

The barrier layer may be formed by a chemical vapor deposition (CVD) process, such as a metal organic chemical vapor deposition (MOCVD) process, an atomic layer deposition (ALD) process, and/or a physical vapor deposition (PVD) process. For example, the titanium barrier layer may be formed by reacting titanium tetrachloride with a reducing agent during a CVD process and the titanium nitride layer may be formed by reacting titanium tetrachloride with ammonia during a CVD process. Thereafter, the conductive material may be deposited onto the substrate.

During depositing of the barrier layer in the processing chamber, metallic materials, such as Ti-based compounds or Ta-based compounds, may be deposited on the chamber components and/or chamber walls. Deposition by-products may be accumulated and deposited on the inner wall of the chamber and/or components disposed in of the chamber. When the accumulated deposition by-products reach a certain thickness, the deposition by-products may peel off or flake off from the inner wall and contaminate the barrier layer by falling onto the substrate, causing defects to the barrier layer. Accordingly, it is important to remove such deposition by-products.

One conventional method for cleaning a metal deposition chamber is to use NF₃ or other fluorine containing gas to react with the deposition by-products, forming volatile fluorides to be pumped out of the chambers. However, some metallic compounds require high temperature to be efficiently removed from the chamber components, and operation at such temperatures is not readily feasible in due to seal service temperature limitations for most chambers currently utilized by integrated circuit fabricators.

Therefore, there is a need for an improved method for chamber cleaning suitable for metal deposition chambers.

### SUMMARY

Embodiments of the invention include methods for in-situ chamber dry clean for metal deposition chambers. In one embodiment, a method for in-situ chamber dry clean after a metal deposition process includes placing a substrate in a processing chamber, performing a metal deposition process on the substrate in the processing chamber, removing the substrate from the support pedestal, and performing an in-situ cleaning process by supplying a cleaning gas containing H₂ to the processing chamber while a dummy substrate is disposed in the processing chamber.

In another embodiment, a method for in-situ chamber dry clean after a metal deposition process is provided that includes placing a substrate in a processing chamber, performing a metal deposition process on the substrate in the processing chamber, removing the substrate from the support pedestal, and performing an in-situ cleaning process. The in-situ cleaning process includes placing a dummy substrate in the processing chamber, forming a hydrogen containing plasma in the processing chamber in the presence of the dummy substrate, and replacing the hydrogen containing plasma with a nitrogen containing plasma in the presence of the dummy substrate.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a cross sectional view of a chemical vapor deposition processing chamber that may be utilized to practice one embodiment of the present invention;

FIG. 2 depicts a flow chart of a in-situ cleaning process for cleaning processing chamber and chamber component in the processing chamber as described in one embodiment herein; and

FIGS. 3A-3B depict cross sectional views of a substrate during processes for forming titanium nitride layers as described in embodiments herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention provide methods and apparatus for in-situ chamber cleaning for metal deposition chambers. The deposition by-products accumulated on the chamber walls or chamber components may be efficiently removed by performing an in-situ cleaning process to remove deposition by-products from the deposition chambers. In one embodiment, the in-situ cleaning process may be performed by providing a dummy substrate in the processing chamber while supplying a hydrogen containing gas into the processing chamber to react with deposition by-products formed on the chamber components. After reaction, the deposition by-products may become brittle and tend to flake off from the chamber walls, falling on the dummy substrate. Subsequently, the dummy substrate is removed from the processing chamber as well as the embrittled deposition by-product particles disposed thereon.

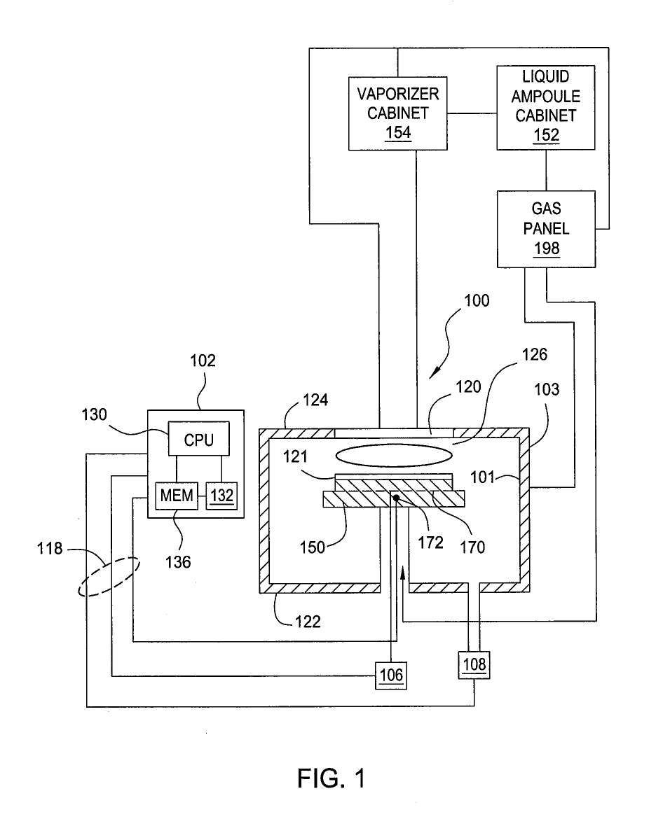

FIG. 1 depicts one embodiment of a metal deposition chamber 100 that may be used to deposit a metal containing layer, such as titanium nitride layer. The metal deposition chamber 100 is configured to perform a MOCVD process for depositing a titanium nitride layer on the substrate. It is contemplated that other suitable types of processing chambers, including those from other manufacturers, may also be adapted to practice the embodiments of the present invention. The metal deposition chamber 100 includes a chamber body 103 enclosed by a lid assembly 124. The lid assembly 124, or other portion of the chamber body 103 includes a gas distributor 120 for providing process gas into the chamber 100. The chamber body 103 generally includes sidewalls 101 and a bottom wall 122 that define an interior volume 126. A support pedestal 150 is provided in the interior volume 126 of the chamber body 103. The pedestal 150 may be fabricated from aluminum, ceramic, and other suitable materials. The pedestal 150 may be moved in a vertical direction inside the chamber body 103 using a displacement mechanism (not shown).

The pedestal 150 may include an embedded heater element 170 suitable for controlling the temperature of a substrate 121 supported thereon. In one embodiment, the pedestal 150 may be resistively heated by applying an electric current from a power supply 106 to the heater element 170. In one embodiment, the heater element 170 may be made of a nickel-chromium wire encapsulated in a nickel-iron-chromium alloy (e.g., INCOLOY®) sheath tube. The electric current supplied from the power supply 106 is regulated by a controller 102 to control the heat generated by the heater element 170, thereby maintaining the substrate 121 and the pedestal 150 at a substantially constant temperature during film deposition. The supplied electric current may be adjusted to selectively control the temperature of the pedestal 150 between about 100 degrees Celsius to about 800 degrees Celsius, such as 250 degrees Celsius to about 500 degrees Celsius, for example, from about 320 degrees Celsius to about 420 degrees Celsius, for example, about 360 degrees Celsius.

A temperature sensor 172, such as a thermocouple, may be embedded in the support pedestal 150 to monitor the temperature of the pedestal 150 in a conventional manner. The measured temperature is used by the controller 102 to regulate the power supplied to the heating element 170 so that the substrate 121 is maintained at a desired temperature.

A vacuum pump 108 is coupled to a port formed in the bottom 122 of the metal deposition chamber 100. The vacuum pump 108 is used to maintain a desired gas pressure in the metal deposition chamber 100. The vacuum pump 108 also evacuates post-processing gases and by-products of the process from the metal deposition chamber 100.

A gas panel 198 is connected to the gas distributor 120 through a liquid ampoule cabinet 152 and a vaporizer cabinet 154. The gas panel 198 introduces gases through the liquid ampoule cabinet 152 and the vaporizer cabinet 154 which carriers a metal precursor from the cabinets 152, 154 to the interior volume 126. One or more apertures (not shown) may be formed in the gas distributor 120 to facilitate gas flowing to the interior volume 126. The apertures may have different sizes, number, distributions, shape, design, and diameters to facilitate the flow of the various process gases for different process requirements. The gas panel 198 may also be connected to the chamber body 103, gas distributor 120, and/or to the pedestal 150 to provide different paths for supplying gases directly into the interior volume 126, such as for purge or other applications. Examples of gases that may be supplied from the gas panel include oxygen containing gas, such as, nitrogen (N₂), ammonia (NH₃), hydrogen (H₂), oxygen (O₂), N₂O, and NO, hydrazine (N₂H₄), methyl hydrazine (CH₃N₂H₃), dimethyl hydrazine ((CH₃)₂N₂H₂), tertbutylhydrazine (C₄H₉N₂H₃), phenylhydrazine (C₆H₅N₂H₃), 2,2′-azotertbutane ((CH₃)₆C₂N₂), ethylazide (C₂H₅N₃), plasmas thereof, derivatives thereof, or combinations thereof, among others.

The liquid ampoule cabinet 152 may store a metal precursor therein which provides source materials used to deposit a metal containing layer on the substrate 121 disposed on the pedestal 150. In one embodiment, the metal precursor may be in a liquid form. One suitable example of liquid precursor used herein includes an organic titanium precursor. The titanium precursor may be a metal-organic compound that includes tetrakis(dialkylamido) titanium compounds, such as tetrakis(dimethylamido) titanium (TDMAT), tetrakis(diethylamido) titanium (TDEAT), tetrakis(ethylmethylamido) titanium (TEMAT), and derivatives thereof. The substrate temperature is maintained at a desired temperature range so that the titanium containing precursor may be thermally decomposed while depositing a titanium nitride material onto the substrate surface. In one embodiment, tetrakis(dialkylamido) titanium compounds are thermally decomposed and the nitrogen of the amido ligands is incorporated as nitrogen within the titanium nitride material during a thermal MOCVD process. However, in an alternative embodiment, a nitrogen precursor may be used during a CVD process to deposit the titanium nitride barrier layers. Suitable examples of nitrogen precursor includes nitrogen (N₂), ammonia (NH₃), hydrazine (N₂H₄), methyl hydrazine (CH₃N₂H₃), dimethyl hydrazine ((CH₃)₂N₂H₂), tertbutylhydrazine (C₄H₉N₂H₃), phenylhydrazine (C₆H₅N₂H₃), 2,2′-azotertbutane ((CH₃)₆C₂N₂), ethylazide (C₂H₅N₃), plasmas thereof, derivatives thereof, or combinations thereof. The nitrogen concentration of the titanium nitride barrier layers may be increased by adding a supplemental nitrogen precursor.

In one embodiment, the gases supplied from the gas panel 198 push the liquid precursor in the ampoule cabinet 152 to the interior volume 126 of the chamber 100 through the vaporizer cabinet 154. The liquid precursor is heated and vaporized in the vaporizer cabinet 154, forming a metal containing vapor which is then injected to the interior volume 126 by the carrier gas. In one embodiment, the vaporizer cabinet 154 may vaporize the liquid precursor at a temperature between about 100 degrees Celsius and about 250 degrees Celsius.

The controller 102 is utilized to control the process sequence and regulate the gas flows from the gas panel 198, the liquid ampoule cabinet 152, and the vaporizer cabinet 154. Bi-directional communications between the controller 102 and the various components of the metal deposition chamber 100 are handled through numerous signal cables collectively referred to as signal buses 118, some of which are illustrated in FIG. 1.

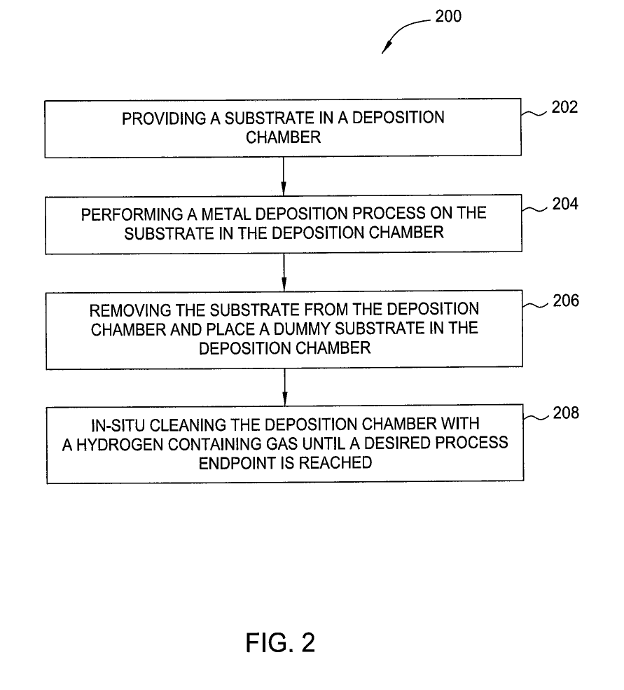

FIG. 2 illustrates a method 200 for in-situ cleaning a deposition chamber according to embodiments of the present invention. The method 200 begins at step 202 when the substrate having a desired feature, e.g., a featured substrate, formed thereon is placed on a support pedestal in a processing chamber, such as the metal deposition chamber 100, as depicted in FIG. 1. “Substrate” or “substrate surface,” as used herein, refers to any substrate or material surface formed on a substrate upon which film processing is performed. For example, a substrate surface on which processing can be performed include materials such as silicon, silicon oxide, strained silicon, silicon on insulator (SOI), carbon doped silicon oxides, silicon nitride, doped silicon, germanium, gallium arsenide, glass, sapphire, quartz, and any other materials such as metals, metal nitrides, metal alloys, and other conductive materials, depending on the application. Barrier layers, metals or metal nitrides, that may be deposited on a substrate surface may include titanium, titanium nitride, titanium silicide nitride, tungsten, tungsten nitride, tungsten silicide nitride, tantalum, tantalum nitride, or tantalum silicide nitride. Substrates may have various dimensions, such as 200 mm or 300 mm diameter wafers, as well as, rectangular or square panes. Substrates include semiconductor substrates, display substrates (e.g., LCD), solar panel substrates, and other types of substrates. Unless otherwise noted, embodiments and examples described herein are conducted on substrates with a 200 mm diameter or a 300 mm diameter. Processes of the embodiments described herein may be used to form or deposit titanium nitride materials on many substrates and surfaces. Substrates on which embodiments of the invention may be useful include, but are not limited to semiconductor wafers, such as crystalline silicon (e.g., Si<100> or Si<111>), silicon oxide, glass, quartz, strained silicon, silicon germanium, doped or undoped polysilicon, doped or undoped silicon wafers and patterned or non-patterned wafers. Substrates may be exposed to a pretreatment process to polish, etch, reduce, oxidize, hydroxylate, anneal and/or bake the substrate surface.

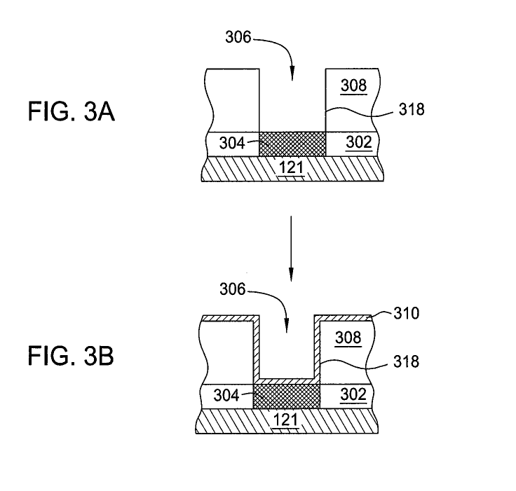

In one embodiment, the featured substrate, such as the substrate 121 depicted in FIG. 1, may have a first insulating layer 302, as shown in FIG. 3A, formed on the substrate 121 and a second insulating layer 308 disposed over the first insulating layer 302. The first and the second insulating layers 302, 308 may be a silicon-containing layer, a silicon dioxide layer or a low-k dielectric layer. Alternatively, the first insulating layers 302 may be part of the substrate 121 so that the second insulating layer 308 may be formed directly on the substrate 121. The second insulating layer 308 may be patterned and etched to form a via 306. In one embodiment, the via 306 may be a void, an aperture, a cavity, a hole, a trench or any suitable structures or features that a titanium nitride layer may be formed therein to form an interconnection structure.

A conductive layer 304 may be disposed in the first insulating layer 302 at a location formed in the second insulating layer 308 connecting to the via 306 to form a conductive path from the first insulating layer 302 to the second insulating layer 308. This conductive path may be utilized to form a contact structure, back end interconnection structure or other suitable metallization structures. Alternatively, the conductive layer 304 may also be as a source or drain region where the via 306 may be formed thereon to form a conductive path for a gate structure. It is contemplated that via 306 may be formed on any suitable substrates that may require a titanium nitride layer to be formed thereon for barrier/liner, metallization or any other purposes. In one embodiment, the conductive layer 304 may be copper, tungsten, aluminum, doped silicon, or other similar conductive material.

At step 204, a metal deposition process is performed to form a barrier layer 310 over the via 306 on the substrate 121, as shown in FIG. 3B. In one embodiment, the barrier layer 310 is a titanium nitride layer. The barrier layer 310 may completely cover exposed surface of substrate 121, such as lower first insulating layer 302, conductive layer 304, and/or the second insulating layer 308. In one embodiment, the barrier layer 310 is deposited by a MOCVD process. In one exemplary embodiment described herein, the barrier layer 310 is deposited by a MOCVD process in the metal deposition chamber 100 depicted in FIG. 1. Alternatively, the barrier layer 310 may be formed by any suitable CVD process, including a thermal MOCVD process, a plasma-enhanced CVD (PE-CVD) process or the like. In an alternative embodiment, the barrier layer 310 may be deposited or formed by an ALD process or a PE-ALD process.

The MOCVD process for depositing the barrier layer 310 includes vaporizing an organic metallic precursor, such as an organic titanium precursor, introducing the vaporized titanium precursor into the metal deposition chamber 100, maintaining the processing chamber at a pressure and the substrate 121 at a temperature suitable for the barrier layer 310, such as a titanium nitride layer to be deposited onto the substrate 121, and thermally decomposing the titanium precursor while depositing barrier layer 310 of titanium nitride onto the substrate 121.

In one embodiment, the titanium precursor used for the MOCVD process may be a metal-organic compound, such as tetrakis(dialkylamido) titanium compounds, which include tetrakis(dimethylamido) titanium (TDMAT), tetrakis(diethylamido) titanium (TDEAT), tetrakis(ethylmethylamido) titanium (TEMAT), and derivatives thereof. The barrier layer 310 of titanium nitride may have a thickness of about 60 Å or less, for example, from about 5 Å to about 50 Å, such as about 50 Å.

During the MOCVD deposition process, several process parameters may be regulated. In one embodiment, the process pressure may be controlled between about 1 Torr to about 10 Torr, for example, about 5 Torr. The substrate temperature may be controlled between about 250 degrees Celsius to about 500 degrees Celsius, such as from about 320 degrees Celsius to about 420 degrees Celsius, for example, about 360 degrees Celsius. The substrate 121 may be exposed to a deposition gas containing the titanium precursor, such as the titanium precursor discussed above, and at least one carrier gas, such as nitrogen, helium, argon, hydrogen, or combinations thereof. In one particular embodiment, the substrate 121 may be exposed to a tetrakis(dialkylamido) titanium compound having a flow rate within a range from about 10 sccm to about 150 sccm, such as about from 20 milligram/min (mgm) to about 100 mgm, and for example about 40 mgm to about 70 mgm, for example, about 55 mgm. The deposition gas may further contain at least one carrier gas having a flow rate within a range from about 1,000 sccm to about 5,000 sccm, such as about 2,000 sccm to about 4,000 sccm, for example, about 3,000 sccm. In another embodiment, the substrate 121 is exposed to a deposition gas containing tetrakis(dimethylamido) titanium (TDMAT) with a flow rate of about 55 sccm, nitrogen gas with a flow rate of about 2,500 sccm, and helium with a flow rate of about 600 sccm during the MOCVD process while forming the barrier layer 310 of titanium nitride.

During deposition, one or more treatment process may be performed to densify the deposited barrier layer 310 as needed. As the barrier layer 310 of titanium nitride deposited on the substrate 121 may have undesired elements, such as carbon, oxygen, and the like, other than titanium and nitrogen sourced from the reacting precursors during depositing, the plasma treatment process performed may efficiently drive out and/or eliminate the amount of undesired elements from the resultant barrier layer 310 of titanium nitride. Removal of the undesired elements from the barrier layer 310 of titanium nitride may promote purity and improve the titanium and nitrogen ratio of the resultant densified titanium nitride barrier layer. In one embodiment, the barrier layer 310 of titanium nitride may be exposed to the treatment plasma having a plasma power of between about 100 watts and about 2000 watts. The plasma treatment process may be performed for about 1 seconds to about 60 seconds, for example, from about 1 second to about 40 seconds. During plasma treatment, the barrier layer 310 of titanium nitride is exposed to a plasma gas mixture containing at least a nitrogen and/or a hydrogen gas. Alternatively, an inert gas, such as argon, helium, neon, or combinations thereof, may also be supplied into the plasma gas mixture during the plasma treatment process.

At step 206, after the substrate 121 is removed from the metal deposition chamber 100, a dummy substrate is then transferred into the processing chamber onto the support pedestal 150. The dummy substrate may have a metal containing material disposed thereon to assist absorbing or adhering particles on the dummy substrate during the subsequent in-situ chamber cleaning process performed at step 208, which will be described in detail below.

In one embodiment, the dummy substrate may comprise, but is not limited to, silicon, silicon oxide, strained silicon, silicon on insulator (SOI), carbon doped silicon oxides, silicon nitride, doped silicon, germanium, gallium arsenide, glass, sapphire, and quartz, and a metal containing material disposed thereon. The metal containing material may be metals, metal nitrides, metal alloys, and other conductive materials, depending on the applications. In one embodiment, the metal containing material disposed on the dummy substrate may be a barrier layer selected from a group consisting of titanium, titanium nitride, titanium silicide nitride, tungsten, tungsten nitride, tungsten silicide nitride, tantalum, tantalum nitride, or tantalum silicide nitride. In an exemplary embodiment, the dummy substrate is a silicon substrate having a titanium nitride layer disposed thereon.

At step 208, an in-situ dry cleaning is performed while having the dummy substrate placed on the pedestal 150. In one embodiment, the in-situ dry cleaning includes introducing a cleaning gas containing H₂. A plasma is formed from the cleaning gas to generate a hydrogen plasma to clean the chamber. In one embodiment, a pre-determined time is used to remove the deposition by-product. After the cleaning process is complete, the processing chamber is now ready for the next deposition process.

In one embodiment, it is believed that the hydrogen gas supplied into the processing chamber during the in-situ plasma cleaning process may help embrittle or fracture the bonding structures of the deposition by-products, thereby resulting in the deposition by-products becoming brittle. The brittle deposition by-products tend to fall off and flake off onto the dummy substrate and are then removed and/or transferred out of the processing chamber after the in-situ cleaning process. During the hydrogen plasma cleaning process, the nucleation and growth of an extensive hydride field is formed in the deposition by-products, thereby resulting in forming cracks in the deposition by-products. Cracks formed in the deposition by-products may assist disintegration of the structure of the deposition by-products, thereby resulting in the deposition by-products falling off from the chamber components, such as chamber walls, onto the surface of the dummy substrate. It is found that small hydrides formed in the deposition by-products may grow together to form the large hydrides, resulting in an auto-catalytic process of hydride nucleation and growth together with brittle nature of the deposition by-products. This results in embrittlement of the hybrids, which will eventually fall on the surface of the dummy substrate and then later will be transferred out of the processing chamber. Additionally, the solubility of hydrogen in the deposition by-products may result in a decrease in atomic binding forces of the metal lattice. This may result in a premature brittle material fracture along the grain boundaries, e.g., intergranular cleavage, or network levels (transgranular cleavage) owing to the decrease of the biding forces, enhancing deconstruction of the deposition by-products and assisting the deposition by-products to be flaked off from the chamber walls. Furthermore, it is also believed that hydrogen plasma formed during the in-situ cleaning process may also assist forming a local dislocation movement in the grain structures of the deposition by-products, leading to a micro crack caused by the formation of micro pores and shearing action. As the grain and bonding structure of the deposition by-products is gradually destroyed, it enhances the possibility of the deposition by-products to fall off from the chamber walls and to be disposed on the dummy substrate.

In one embodiment, the in-situ cleaning can be performed using hydrogen (H₂) as a cleaning gas with a flow rate between 50 to 2000 standard cubic centimeters per minute (sccm), for example, from about 500 to 1500 sccm, such as at about 1000 sccm. A RF power can be applied from a plasma power source in a range between 150 and 5000 W, for example, from about 300 to 2000 W, for example, about 1750 W at a RF frequency about 350 KHz. The pressure in the processing chamber can be controlled between about 2 to 50 Torr, for example, from about 1 to 20 Torr, for example, about 2.5 Torr. The processing chamber may be exposed to the cleaning gas for a time period between about 50 seconds and about 2000 seconds, such as about 100 seconds and about 1000 seconds, for example about 600 seconds.

The in-situ dry cleaning process performed at step 208 may optionally include providing nitrogen (N₂) plasma after the H₂ plasma. It has been found that use of N₂ plasma after the H₂ plasma further reduces the amount of defects present in subsequently process substrates. It is believed that the N₂ plasma reacts with weakened/dangling bonds resulting from exposure to the H₂ plasma treatment, thus increasing the stress on material deposited on the process kit and increasing the probability that the deposited material will flake off onto the dummy wafer. In one embodiment, the flow of hydrogen (H₂) cleaning gas is stopped, and replaced with a flow of nitrogen (N₂) cleaning gas. The N₂ gas may need to be ignited if the H₂ plasma extinguishes prior to being replaced.

In one embodiment, the in-situ chamber dry clean at step 208 includes placing a dummy substrate in the processing chamber, forming a hydrogen containing plasma in the processing chamber in the presence of the dummy substrate, and replacing the hydrogen containing plasma with a nitrogen containing plasma in the presence of the dummy substrate. An exemplary process for forming the nitrogen containing plasma includes providing about 500 to about 5000 sccm (for example, about 1000 to about 3000 sccm) of N₂ into the processing chamber, proving RF power in a range between 150 and 5000 W (for example about 1750 W of plasma power), maintaining the pressure within the chamber at about 0.1 and about 10.0 Torr (for example 0.8 to 5.0 Torr, such as 1.3 Torr), providing a showerhead-to-substrate spacing of about 350 mils, and maintaining the plasma for about 5 to 600 or more second, for example 35 seconds.

The in-situ cleaning process may be run periodically after processing a number of featured substrates (product substrate), such as the substrate 121 described above. In one embodiment, the in-situ cleaning process may be performed in the processing chamber after performing deposition process after over or every one hundred and twenty five substrates. In another embodiment, the in-situ cleaning process may be performed in the processing chamber every twelve hours. In yet another embodiment, the in-situ cleaning process may be performed as needed as the processing chamber gets deposition by-products accumulation.

While the foregoing is directed to embodiments of the present invention, other and further embodiments of the invention may be devised without departing from the basic scope thereof, and the scope thereof is determined by the claims that follow.

1. A method for in-situ chamber dry clean after a metal deposition process, comprising:
placing a substrate in a processing chamber;
performing a metal deposition process on the substrate in the processing chamber;
removing the substrate from the support pedestal; and
performing an in-situ cleaning process by supplying a cleaning gas containing H₂ to the processing chamber while a dummy substrate is disposed in the processing chamber.

2. The method of claim 1, wherein the in-situ cleaning process comprises:
supplying a cleaning gas containing N₂ to the processing chamber while the dummy substrate is disposed in the processing chamber.

3. The method of claim 2, wherein the in-situ cleaning process comprises:
supplying the cleaning gas containing N₂ after a flow of the cleaning gas containing H₂ into the processing chamber has been stopped.

4. The method of claim 1, wherein the performing a metal deposition process comprises depositing a barrier layer selected from a group comprising titanium, titanium nitride, titanium silicide nitride, tungsten, tungsten nitride, tungsten silicide nitride, tantalum, tantalum nitride, or tantalum silicide nitride.

5. The method of claim 1, wherein a flow rate of the cleaning gas containing H₂ is between 50 sccm to 2000 sccm.

6. The method of claim 5, wherein the processing chamber is exposed to the cleaning gas containing H₂ for about 50 seconds to about 2000 seconds.

7. The method of claim 5, wherein a RF power between 150 W and 5000 W is applied.

8. The method of claim 5, wherein a pressure in the processing chamber is controlled between 2 Torr to 50 Torr.

9. The method of claim 3, wherein a flow rate of the cleaning gas containing N₂ is between 500 sccm to 5000 sccm.

10. A method for in-situ chamber dry clean after a metal deposition process, comprising:
placing a substrate in a processing chamber;
performing a metal deposition process on the substrate in the processing chamber;
removing the substrate from the support pedestal; and
performing an in-situ cleaning process comprising:
placing a dummy substrate in the processing chamber;
forming a hydrogen containing plasma in the processing chamber in the presence of the dummy substrate; and
replacing the hydrogen containing plasma with a nitrogen containing plasma in the presence of the dummy substrate.

11. The method of claim 10, wherein the dummy substrate is selected from a group comprising silicon, silicon oxide, strained silicon, silicon on insulator, carbon doped silicon oxides, silicon nitride, doped silicon, germanium, gallium arsenide, glass, sapphire, and quartz.

12. The method of claim 11, wherein the metal deposition process forms a barrier layer selected from a group consisting of titanium, titanium nitride, titanium silicide nitride, tungsten, tungsten nitride, tungsten silicide nitride, tantalum, tantalum nitride, or tantalum silicide nitride.

13. The method of claim 10, wherein the nitrogen containing plasma is ignited prior to replacing the hydrogen containing plasma.
